(19) United States
(12) Patent Application Publication
(10) Pub. No.: US 2026/0000983 A1
(43) Pub. Date: Jan. 1, 2026

(54) ADJUSTING COMMUNICATIONS INCLUDING MESSAGE TIME SHIFTING AND SUMMARIZATION FOR OPTIMUM PRESENTATION TO PLAYER

(71) Applicant: Sony Interactive Entertainment Inc., Tokyo (JP)

(72) Inventors: Joseph Sommer, San Mateo, CA (US); Anders Lykkehoy, San Mateo, CA (US)

(21) Appl. No.: 18/761,284

(22) Filed: Jul. 1, 2024

(51) Int. Cl. A63F 13/54; A63F 13/87

(52) U.S. Cl. CPC A63F 13/54; A63F 13/87; A63F 2300/308

(57) ABSTRACT

A method for managing incoming communications for a player of a video game is provided, including: during gameplay of the video game by the player, receiving a plurality of communications for the player; responsive to the communications being received at substantially similar times, then analyzing the communications to determine their content; based on the content of the communications, then rendering a first one of the communications to the player in substantial real-time, and delaying rendering a second one of the communications to the player.

### BACKGROUND OF THE INVENTION

Modern video games are capable of delivering highly engaging and immersive experiences. Along with gameplay of the video game itself, many video games and platforms support messaging between players, spectators, or even others. In some instances, there can be many communications occurring simultaneously or within close timing of each other, such that it becomes difficult for the player to comprehend the communications while also concentrating on their gameplay of the video game.

It is in this context that implementations of the disclosure arise.

### SUMMARY OF THE INVENTION

Implementations of the present disclosure include methods, systems and devices for adjusting communications including message time shifting and summarization for optimum presentation to a player of a video game.

In some implementations, a method for managing incoming communications for a player of a video game is provided, including: during gameplay of the video game by the player, receiving a plurality of communications for the player; responsive to the communications being received at substantially similar times, then analyzing the communications to determine their content; based on the content of the communications, then rendering a first one of the communications to the player in substantial real-time, and delaying rendering a second one of the communications to the player.

In some implementations, analyzing the communications is configured to determine a relevance of content of the communications to the gameplay of the video game, and wherein the first one of the communications is determined to have greater relevance to the gameplay than the second one of the communications.

In some implementations, the method further includes: analyzing game state data of the video game to identify events occurring in the gameplay; wherein analyzing the communications is configured to determine the relevance of the content of the communications to the events occurring in the gameplay.

In some implementations, analyzing the communications uses an artificial intelligence (AI) model.

In some implementations, the communications being received at substantially similar times is defined by receipt within a predefined time period.

In some implementations, the communications being received at substantially similar times is defined by the communications being overlapping in time.

In some implementations, the communications include one or more of voice communications and text communications.

In some implementations, the first communication is rendered as audio and the second communication is rendered as text.

In some implementations, the first and second communications are voice audio communications, and wherein rendering the second communication includes converting voice audio of the second communication to a text format.

In some implementations, rendering the second communication includes applying an AI model to generate a summary of the second communication, and presenting the summary to the player.

In some implementations, a non-transitory computer-readable medium is provided having program instructions embodied thereon that, when executed by at least one computing device, cause said at least one computing device to perform a method for managing incoming communications for a player of a video game, said method including: during gameplay of the video game by the player, receiving a plurality of communications for the player; responsive to the communications being received at substantially similar times, then analyzing the communications to determine their content; based on the content of the communications, then rendering a first one of the communications to the player in substantial real-time, and delaying rendering a second one of the communications to the player.

Other aspects and advantages of the disclosure will become apparent from the following detailed description, taken in conjunction with the accompanying drawings, illustrating by way of example the principles of the disclosure.

### BRIEF DESCRIPTION OF DRAWINGS

The disclosure may be better understood by reference to the following description taken in conjunction with the accompanying drawings in which:

FIG. 1 conceptually illustrates receipt of several communications occurring within a given time frame, and time-shifting of a communication, in accordance with implementations of the disclosure.

FIG. 2 conceptually illustrates conversion of voice audio to text, in accordance with implementations of the disclosure.

FIG. 3 conceptually illustrates audio modification of simultaneous spoken audio to improve comprehension, in accordance with implementations of the disclosure.

FIG. 4 conceptually illustrates a process in which player receptivity is used to affect presentation of communications, in accordance with implementations of the disclosure.

FIG. 5 conceptually illustrates a process for condensing messages based on similarity, in accordance with implementations of the disclosure.

FIG. 6 illustrates components of an example device 600 that can be used to perform aspects of the various embodiments of the present disclosure.

### DETAILED DESCRIPTION OF THE INVENTION

Implementations of the present disclosure include methods, systems, and devices for adjusting communications including message time shifting and summarization for optimum presentation to a player of a video game.

Modern video games are capable of supporting or otherwise integrating with many types of communication between players, spectators or other persons. In the context of a video game, there can be player-to-player communications during gameplay. Furthermore, if spectating is enabled, then communications between spectators and the player may also be supported. Additionally, integrations with third-party communication services are possible, such as social network communication services and others, thus expanding even further the possibility for various communications with the player. Communications can take the form of voice audio, text, and even video streams of individuals.

In view of these kinds of communication and messaging possibilities, it is often the case that a player will receive multiple communications or messages simultaneously or within a short timeframe, such that it may become difficult for the player to fully comprehend the communications while also concentrating on their gameplay of the video game.

Hence, implementations of the present disclosure provide methods and systems that aid a player by prioritizing and managing incoming communications in a way that enables the player to better comprehend the communications. Analysis of game context of gameplay of the video game, current player sentiment, and messaging characteristics can be used to determine when player is able to receive and handle messaging and how the messaging is presented. Based on a window of opportunity when a player is receptive for incoming messages, the messaging can be modified for optimum presentation to player, including time shifting of messages, message shrinkage or elongation, message conversion (e.g., speech to text), mixing or interleaving or interspersing multiple messages delaying of messaging, blocking of messaging (e.g., stale), etc.

Based on game context analysis and player sentiment and priority of messaging, the messaging can be untouched or reformatted/translated (e.g., using ChatGPT) for presentation to the user, such as providing for audio pass-through when the player is highly receptive to messaging, or conversion to text and/or sub-titling when the player is moderately engaged with game play.

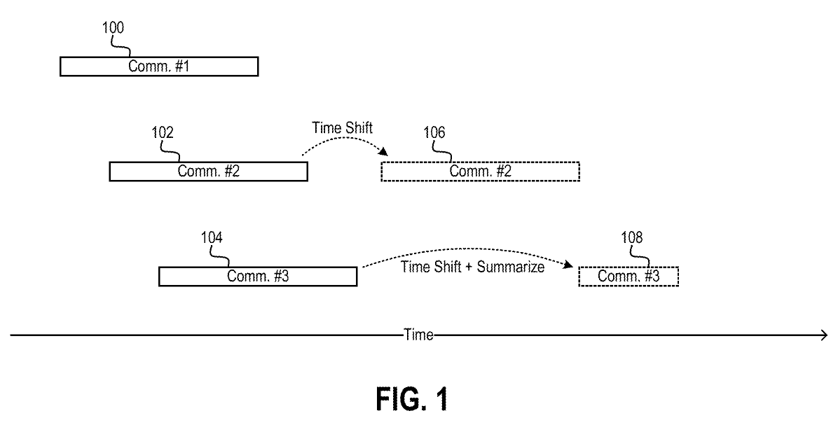

FIG. 1 conceptually illustrates receipt of several communications occurring within a given time frame, and time-shifting of a communication, in accordance with implementations of the disclosure.

In the illustrated implementation, various communications 100, 102, and 104 are received over a short timeframe, for example, within a time period such as about 1 to 5 seconds of each other. The communications are received within close timing of each other such that if presented to the player in real-time upon receipt, the player may find it difficult or be unable to fully comprehend one of the communications without being presented with another one of the communications at the same time. For example, if the communications are voice communications, then the player might hear multiple people talking at the same time. Or if the communications are text communications, the player would see them appear at such a rate as to make it difficult or stressful to read them while also focusing on gameplay of the video game. It will be appreciated that similar difficulties for the player arise in the case of mixed types of communications, such as some voice and some text messages occurring at the same time or within a short time period. This presents a challenge of how to handle multiple streams of communication.

In some implementations, a given communication can be time-shifted so as not to interfere with another communication. For example, in the illustrated implementation, the communication 102 is overlapping with the communication 100, and therefore the communication 102 is time-shifted to a later time, as represented by reference 106. That is, communication 102 is not presented to the player in (substantial) real-time as it is sent or being sent, but is instead delayed in its presentation to a later time. In this case, the communication 102 is time-shifted so as to begin at a time after communication 100 has been completed. In the case of communication 100 being an audio/video communication, then presentation of communication 102 may be delayed until the audio/video of the sender of communication 100 is complete or after the audio/video of the sender is no longer detected or received for a sufficient time. In the case of communication 100 being a text communication/message, then the communication 102 can be delayed by an amount of time proportional to the length of the communication 100, so as to provide the player sufficient time to comprehend the communication 100 before being presented with communication 102.

In order to time-shift communication 102, it will be appreciated that in the case that communication 102 is audio/video, then the audio/video can be recorded and then played back at the later time. In some implementations, the recording and time-shifting of the communication 102 is in response to detecting that the communication 100 is currently ongoing or recently commenced or displayed (e.g. within a time period proportional to the length of communication 100). It will be appreciated that in the case of the communication 102 being a text communication, then its display can be delayed until the later time.

In some implementations, a communication can be further processed to provide additional benefits if it is being time-shifted. For example, in the illustrated implementation, a communication 104 is time-shifted and additionally summarized into a communication 108 that is presented at a later time than the original communication 104. That is, the communication 104 is summarized by processing the communication 104 so as to condense or shorten the communication 104 while preserving its semantic meaning. In some implementations, summarization of the communication 104 is accomplished by applying an artificial intelligence (AI) or machine learning (ML) model to the communication 104 to generate the summarized version as communication 108. It will be appreciated that by summarizing the communication 104, it can be comprehended by the player more quickly than the original communication 104. Hence, a time-shifted communication can be not only less interfering with other communications but also made more efficient to comprehend for the player.

In some implementations, communications which are time-shifted can also be changed from one format to another. For example, in some implementations, a time-shifted communication that is originally an audio communication can be translated using a speech-to-text process into a text communication that is displayed rather than being played as audio. It will be appreciated that such translation may also be configured to summarize the communication. Or in other implementations, a time-shifted communication that is originally a text communication can be translated using a text-to-speech process into an audio communication.

In some implementations, communications are prioritized and presented in various ways depending on their prioritization. For example, when multiple communications are received substantially simultaneously or within a short timeframe, the communications can be prioritized, and a higher priority communication can be presented in real-time, while a lower priority communication is time-shifted and possibly summarized and/or changed in terms of format. In some implementations, the extent of the time-shifting of a given communication can be determined in part by its prioritization, such that lower priority communications are time-shifted to a greater extent than higher priority communications. A similar concept can be applied to summarization, so that lower priority communications are subject to greater summarization (more compressed/condensed) than higher priority communications. In this way, higher priority communications are presented with greater fidelity to the original than lower priority communications.

It will be appreciated that the prioritization of communications can be based on various factors. In some implementations, communications are prioritized, at least in part, based on determining/analyzing their content (e.g. using an AI/ML model). For example, the urgency of communications can be determined by understanding the semantic meaning of their content, and higher urgency communications can be treated with higher priority. In some implementations, the relevance of a communication to current video game gameplay can be determined and used to determine priority, so that communications with greater relevance to the current gameplay are given higher priority. It will be appreciated that the current gameplay can be determined by analyzing game state data from the video game to determine events and/or objects involved in the current gameplay, and this information can be used to determine the relevance of a given communication to the events/objects of the gameplay.

In further implementations, additional factors can be considered to determine prioritization, such as the specific sender of the communication. For example, communications from members of the player’s team may be prioritized over communications from others (e.g. members of an opposing team, spectators, etc.). Or if the player is known to communicate with a particular user with high frequency, then communications from that user may be prioritized over others with whom the player communicates less frequently.

While time-shifting of communications has been described in some implementations in terms of shifting to a time after completion of a given communication, it will be appreciated that in some implementations, a given communication can be time-shifted or delayed, but to an extent that is less than the time required for completion of an ongoing communication. In this manner, the time-shifted communication is delayed in its start or presentation, allowing greater time for comprehension of the existing communication before introducing the time-shifted communication. As noted, the extent of this delay can be based on the prioritization of the communication.

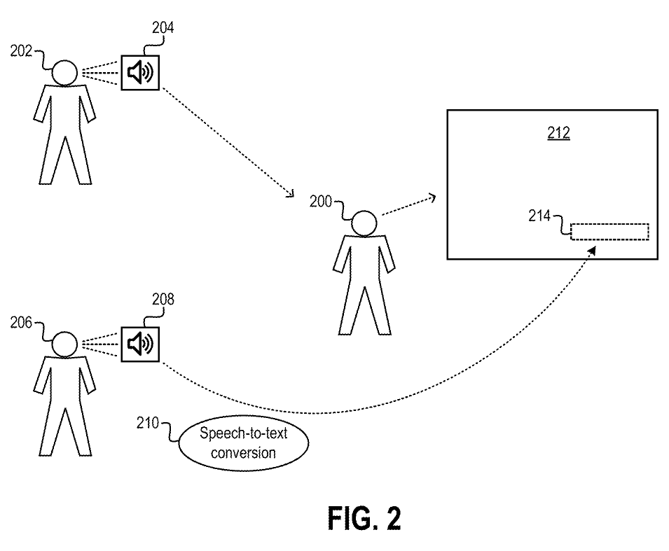

FIG. 2 conceptually illustrates conversion of voice audio to text, in accordance with implementations of the disclosure.

In the illustrated implementation, a player 200 is engaged in gameplay of a video game, and is more specifically viewing a game scene 212. At the same time, two additional persons 202 and 206 are simultaneously attempting to talk to the player 200. In various implementations, the person 202/206 can be another player participating in the video game, a friend on the gaming platform supporting the video game, a spectator, etc., and may further be situated remotely from the player 200 or even possibly in the same local environment as the player 200.

The speech audio 204 of the person 202, and the speech audio 208 of the person 206, are conceptually illustrated. In the illustrated implementation, in order to enable the player 200 to better differentiate the speech of both persons, the speech audio 204 of the person 202 is presented directly as audio in substantial real-time to the player 200, whereas the speech audio 208 is not presented as audio, but is instead converted to text using a speech-to-text conversion process 210. And the generated text is then displayed as message 214 in the game scene 212, so that rather than hear the speech audio 208, the player can read a transcript of the speech audio 208. In this manner, the player 200 receives communications in different modes of presentation that would normally be in the same mode, which can make it easier for the player 200 to comprehend the communications.

In some implementations, the communication from person 202 is prioritized over that of person 206, and therefore the speech audio 204 of person 202 is presented in its native format (audio) whereas the speech audio 208 of person 206 is converted and displayed as text as described. The determination of prioritization can be performed, at least in part, based on analyzing content of the communications as described herein.

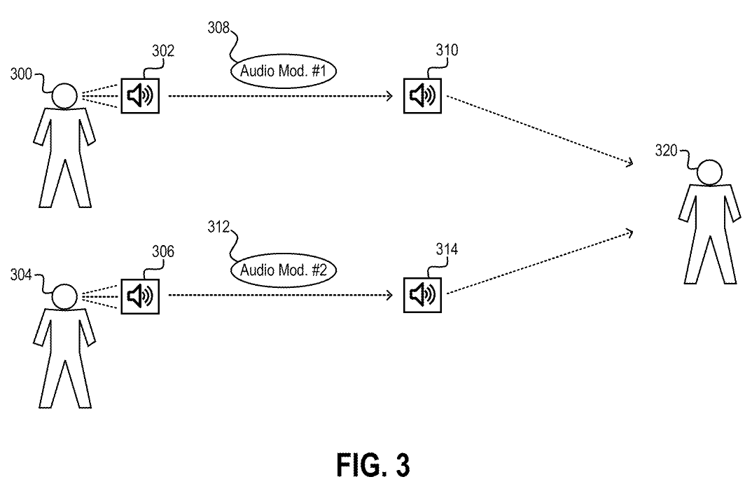

FIG. 3 conceptually illustrates audio modification of simultaneous spoken audio to improve comprehension, in accordance with implementations of the disclosure.

In the illustrated implementation, persons 300 and 304 are simultaneously speaking to player 320. In order to improve the ability of player 320 to comprehend both persons, in some implementations, the voice audio is modified in different ways to help distinguish the different voices. For example, the voice audio 302 of person 300 is modified using an audio modification 308 to generate modified voice audio 310. And the voice audio 306 of person 304 is modified using an audio modification 312 to generate modified voice audio 314. The modified voice audio 310 and modified voice audio 314 are presented to the player in substantial real-time. The audio modifications 308 and 312 are configured to be different so as to make the voices of persons 300 and 304 more distinguishable in the modified voice audio 310 and 314. In this way, the player 320 can more easily distinguish between and understand the speech of persons 300 and 304.

In some implementations, the audio modifications are defined by applying differing audio equalizations to the voice audio of each person. For example, the audio modification 308 can be defined by applying a low-pass filter, whereas the audio modification 312 can be defined by applying a high-pass filter, so that the resulting modified voice audio 310 and 314 are equalized differently and more distinguishable. In some implementations, the audio modifications are defined by applying different speeds to the voice audio of each person, such as by speeding up one and slowing down the other. In other implementations, other kinds of modifications can be applied to make the voice audio of the persons more distinguishable from each other. In some implementations, this effect can be combined with spatial audio presentation, such that the modified voice audio 310 and 314 are spatially presented so as to sound like they are coming from at different locations/directions relative to the player 320.

Additionally, it will be appreciated that the audio modifications can be chosen based on prioritization of the communications, so that the higher priority communication is more easily heard than the lower priority communication.

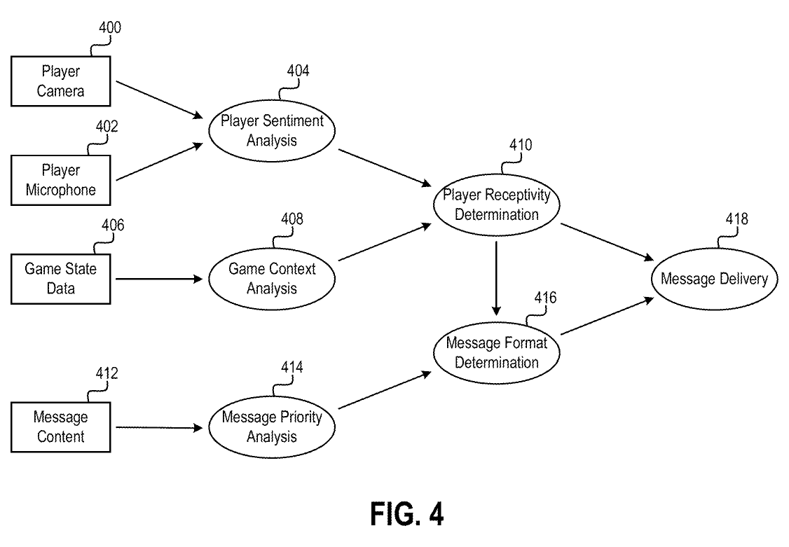

FIG. 4 conceptually illustrates a process in which player receptivity is used to affect presentation of communications, in accordance with implementations of the disclosure.

It will be appreciated that a player of a video game will go through varying periods when they are more occupied and less occupied with gameplay. Accordingly, the player may be more receptive or less receptive to communications at various points during their gameplay of the video game. Thus, in some implementations, presentation of communication to the player is dependent on how receptive they are determined to be at a given time.

For example, in the illustrated implementation a player sentiment analysis process 404 is performed to analyze the sentiment of the player during gameplay. In some implementations, the player’s sentiment is determined from analyzing video of the player captured by a player camera 400, and further from analyzing audio of the player captured by a player microphone 402. In some implementations, determining the sentiment of the player includes determining a stress level or a concentration level of the player based on such inputs. It will be appreciated that stress and concentration levels may not always correlate with high physical activity by the player, as the user may in fact be still and quiet, but highly concentrating on deciding their next move. In some implementations, player sentiment is performed using an AI/ML model to analyze the video and audio of the player.

In addition to player sentiment, the game context of the video game can be used to help determine player receptivity. A game context analysis process 408 is performed using game state data 406 of the video game. The game state data 406 is analyzed to determine characteristics of the activity occurring in the video game, such as the types of activity and levels or intensity of activity.

Based on the player sentiment and characteristics of the game context, the receptiveness of the player to incoming communications can be determined as indicated at reference 410. It will be appreciated that during times when the player is more highly stressed and/or the game context exhibits high levels of activity, the player may be less receptive to receiving communication, whereas when the player is less stressed and/or the game context exhibits low levels of activity, then the player may be more receptive to receiving communication.

In some implementations, a message priority analysis 414 is performed to analyze message content 412 to determine the prioritization of a given message. And accordingly, communications can be presented to the player based on their prioritization and based on the receptivity of the player, as indicated at reference 418. For example, a higher priority message may be presented to the player regardless of their receptivity at the time. Whereas a lower priority message might be time-shifted to a time when the player is determined to be more receptive to receiving communications.

Additionally, in some implementations, the player receptivity can be used to determine the message format, as indicated at reference 416. For example, when the player is determined to be less receptive to communications, then an audio message may be converted to text and displayed rather than being played as audio, so as to deliver the message in a manner that is less intrusive for the player.

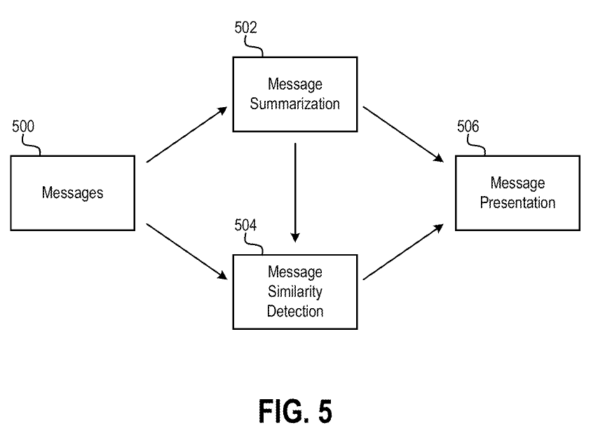

FIG. 5 conceptually illustrates a process for condensing messages based on similarity, in accordance with implementations of the disclosure.

In some implementations, a player may receive multiple messages 500, some of which may be similar to each other. Accordingly, in some implementations, a message similarity detection process 504 is applied to the messages to determine the extent of similarity between messages. In some implementations, messages which are sufficiently similar to each other can be presented at reference 506 in a manner that condenses the similar messages. For example, multiple messages may be displayed in a layered or stacked or collapsed format, so that some or most of the similar messages are hidden, and that can be expanded if selected by the player to enable viewing of more of the similar messages. Or a single representative message is displayed, with additional information indicating the number and/or names of other persons that also communicated a similar message.

In some implementations, a message summarization process 502 can be applied to some or more of the messages 500, and message similarity detection 504 can be performed on the summaries to determine similarity. In this way, similar messages received by the player may be further condensed so that they can be easily comprehended.

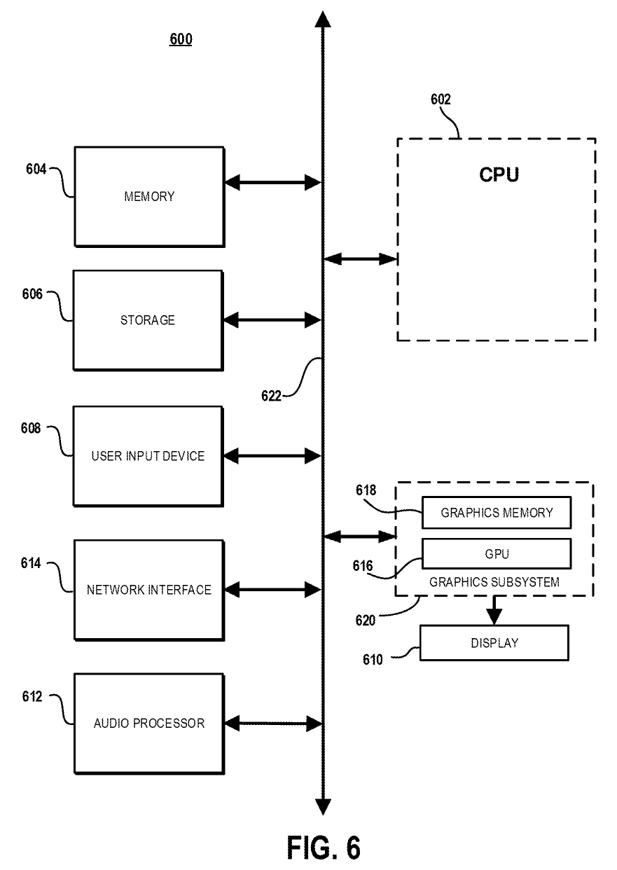

FIG. 6 illustrates components of an example device 600 that can be used to perform aspects of the various embodiments of the present disclosure. This block diagram illustrates a device 600 that can incorporate or can be a personal computer, video game console, personal digital assistant, a server or other digital device, suitable for practicing an embodiment of the disclosure. Device 600 includes a central processing unit (CPU) 602 for running software applications and optionally an operating system. CPU 602 may be comprised of one or more homogeneous or heterogeneous processing cores. For example, CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 600 may be a localized to a player playing a game segment (e.g., game console), or remote from the player (e.g., back-end server processor), or one of many servers using virtualization in a game cloud system for remote streaming of gameplay to clients.

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600, including CPU 602, memory 604, data storage 606, user input devices 608, network interface 610, and audio processor 612 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Graphics memory 618 can be integrated in the same device as GPU 608, connected as a separate device with GPU 616, and/or implemented within memory 604. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs.

The graphics subsystem 614 periodically outputs pixel data for an image from graphics memory 618 to be displayed on display device 610. Display device 610 can be any device capable of displaying visual information in response to a signal from the device 600, including CRT, LCD, plasma, and OLED displays. Device 600 can provide the display device 610 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the "cloud" that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user’s available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user’s eyes. Thus, the HMD can provide display regions to each of the user’s eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user’s interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for managing incoming communications for a player of a video game, comprising:
during gameplay of the video game by the player, receiving a plurality of communications for the player;
responsive to the communications being received at substantially similar times, then analyzing the communications to determine their content;
based on the content of the communications, then rendering a first one of the communications to the player in substantial real-time, and delaying rendering a second one of the communications to the player.

2. The method of claim 1, wherein analyzing the communications is configured to determine a relevance of content of the communications to the gameplay of the video game, and wherein the first one of the communications is determined to have greater relevance to the gameplay than the second one of the communications.

3. The method of claim 2, further comprising:
analyzing game state data of the video game to identify events occurring in the gameplay;
wherein analyzing the communications is configured to determine the relevance of the content of the communications to the events occurring in the gameplay.

4. The method of claim 1, wherein analyzing the communications uses an artificial intelligence (AI) model.

5. The method of claim 1, wherein the communications being received at substantially similar times is defined by receipt within a predefined time period.

6. The method of claim 1, wherein the communications being received at substantially similar times is defined by the communications being overlapping in time.

7. The method of claim 1, wherein the communications include one or more of voice communications and text communications.

8. The method of claim 1, wherein the first communication is rendered as audio and the second communication is rendered as text.

9. The method of claim 8, wherein the first and second communications are voice audio communications, and wherein rendering the second communication includes converting voice audio of the second communication to a text format.

10. The method of claim 1, wherein rendering the second communication includes applying an AI model to generate a summary of the second communication, and presenting the summary to the player.

11. A non-transitory computer-readable medium having program instructions embodied thereon that, when executed by at least one computing device, cause said at least one computing device to perform a method for managing incoming communications for a player of a video game, said method comprising:
during gameplay of the video game by the player, receiving a plurality of communications for the player;
responsive to the communications being received at substantially similar times, then analyzing the communications to determine their content;
based on the content of the communications, then rendering a first one of the communications to the player in substantial real-time, and delaying rendering a second one of the communications to the player.

12. The non-transitory computer-readable medium of claim 11, wherein analyzing the communications is configured to determine a relevance of content of the communications to the gameplay of the video game, and wherein the first one of the communications is determined to have greater relevance to the gameplay than the second one of the communications.

13. The non-transitory computer-readable medium of claim 12, wherein the method further comprising:
analyzing game state data of the video game to identify events occurring in the gameplay;
wherein analyzing the communications is configured to determine the relevance of the content of the communications to the events occurring in the gameplay.

14. The non-transitory computer-readable medium of claim 11, wherein analyzing the communications uses an artificial intelligence (AI) model.

15. The non-transitory computer-readable medium of claim 11, wherein the communications being received at substantially similar times is defined by receipt within a predefined time period.

16. The non-transitory computer-readable medium of claim 11, wherein the communications being received at substantially similar times is defined by the communications being overlapping in time.

17. The non-transitory computer-readable medium of claim 11, wherein the communications include one or more of voice communications and text communications.

18. The non-transitory computer-readable medium of claim 11, wherein the first communication is rendered as audio and the second communication is rendered as text.

19. The non-transitory computer-readable medium of claim 18, wherein the first and second communications are voice audio communications, and wherein rendering the second communication includes converting voice audio of the second communication to a text format.

20. The non-transitory computer-readable medium of claim 11, wherein rendering the second communication includes applying an AI model to generate a summary of the second communication, and presenting the summary to the player.
